(19) United States
(12) Patent Application Publication
(10) Pub. No.: US 2010/0196545 A1
(43) Pub. Date: Aug. 5, 2010

(54) BEVERAGE PREPARATION MATERIAL

(75) Inventors: Gaelle Buffet, Workingham (GB); John Charles Cooke, Farnborough (GB); Kevin Chandler, Basingstoke (GB); Paul Fletcher, Camberley (GB); Jon William Shaw, Basingstoke (GB)

Correspondence Address: FULBRIGHT & JAWORSKI, LLP, 1301 MCKINNEY, SUITE 5100, HOUSTON, TX, 77010-3095, US

(73) Assignee: MARS INCORPORATED, Mclean, VA (US)

(21) Appl. No.: 12/526,932

(22) PCT Filed: Feb. 28, 2008
(86) PCT No.: PCT/GB08/00693

§ 371 Date: Mar. 29, 2010

(30) Foreign Application Priority Data
Mar. 2, 2007 (GB) 0704095.9
Jul. 17, 2007 (GB) 0713881.1

(51) Int. Cl. B65D 85/804; A47J 31/06

(52) U.S. Cl. 426/79; 426/431

(57) ABSTRACT

A beverage preparation material (1) comprising a substantially insoluble and water-permeable tiller matrix (3) having a beverage ingredient (2) dispersed therein, wherein a plurality of layers, cells, or individual particles (2) of said beverage ingredient are held in a spaced-apart relationship within said material by regions of said tiller matrix (3). Also provided are beverage preparation pods and capsules (5) containing a beverage preparation material according to the invention.

### CROSS-REFERENCE TO RELATED APPLICATIONS

This application is a national stage filing of PCT/GB2008/000693 filed Feb. 28, 2008, claiming priority from GB 0704095.9 filed on Mar. 2, 2007 and GB 0713881.1 filed on Jul. 17, 2007.

### TECHNICAL FIELD

The present invention relates to materials for use in the preparation of beverages, to methods of preparation of beverages from such materials, and to beverage preparation capsules containing such materials.

### BACKGROUND OF THE INVENTION

It has long been known to prepare beverages such as coffee or tea by manual immersion in hot water of filter packs containing ground coffee or leaf tea. These tea bags and coffee bags present difficulties of handling and disposal, and the strength of the beverage is critically dependent on the amount of time that the filter bag is immersed in the hot water.

GB-A-2292554, US-A-20040255788, US-A-20020005027 and WO-A-9623695 describe filter packs that are segmented into two or more compartments, e.g. for retaining different types of coffee, or for containing tea in one compartment and a beverage whitener or flavoring in another compartment. In some embodiments, the compartments can be separated from each other, e.g. by tearing, to allow the compartments to be infused separately or sequentially. Alleged advantages include improved ease of handling, improved control over beverage strength, and an extended range of beverage types.

A number of beverage making systems are known in which the beverage is made by inserting a capsule containing a particulate beverage making ingredient, such as ground coffee, into a beverage making station of a beverage making apparatus. The apparatus then injects water into the capsule, where the beverage making ingredient dissolves in, or infuses into, the water to form the beverage. The beverage flows out of the capsule through a suitable outlet, which may be simply an opening or perforation in the capsule, or it may comprise an outlet tube that pierces an outlet region of the capsule. The capsule may incorporate a filter to prevent passage of solid components such as coffee grounds out of the capsule. Beverage making systems of this general type are described for example in WO 94/01344, EP-A-0512468 and EP-A-0468079 (all Nestle), in U.S. Pat. No. 5,840,189 (Keurig), in EP-A-0272922 (Kenco), in EP-A-0821906 (Sara Lee) and in EP-A-0179641 and WO 02/19875 (Mars), the entire contents of all of which are incorporated herein by reference.

A difficulty that can arise with the above systems is incomplete dissolution or extraction of the beverage ingredients inside the capsule, for example due to channeling of water through the bed of ingredient inside the capsule. Another difficulty that can arise is excessive system back-pressure due to blocking of the water flow, or of the filter, by the particulate ingredient inside the capsule.

The present invention seeks to overcome these problems, and further provides additional advantages.

### BRIEF SUMMARY OF THE INVENTION

In a first aspect, the present invention provides a beverage preparation material comprising a substantially insoluble and water-permeable filter matrix having a beverage ingredient dispersed therein, wherein a plurality of layers, cells, or individual particles of the beverage ingredient are held in a spaced-apart relationship within said material by said filter matrix.

The term “filter matrix” refers to a porous solid body that allows the passage of liquid water but substantially blocks the passage of particulate beverage preparation ingredients such as ground coffee, leaf tea, or water-soluble particulate ingredients such as hot chocolate, particulate whiteners and sweeteners. This allows beverages to be prepared by passing aqueous liquid through the material of the present invention. Extraction and dissolution of the beverage ingredients is highly efficient because agglomeration of the ingredient layers, cells or particles is prevented by the matrix. The porosity of the matrix is maintained or increased during the extraction or dissolution procedure, whereby system pressure in the beverage preparation equipment is lower and more predictable. In other words, the material of the present invention comprises a three-dimensional body of filtration material providing a matrix in which the beverage preparation ingredients are distributed in spaced-apart fashion. The materials according to the present invention suitably have a major part (at least about 50%, preferably at least about 75% or 90% by weight) of the filter matrix located in the interior of the material, for example at least about 1 mm from the surface of the material. The term “filter matrix” herein therefore does not encompass a filtration envelope having multiple compartments of the kind described in GB-A-2292554, US-A-20040255788, US-A-20020005027 or WO-A-9623695, since these structures have a filtration material in the form of a sheet only on the outside surface thereof.

The beverage ingredient is dispersed in the matrix as a plurality of layers, cells (i.e. small enclosed bodies of the beverage ingredient) or individual particles separated by the matrix material. Suitably, adjacent layers, cells or individual particles are spaced apart by less than about 2 mm, for example less than about 1 mm in the matrix. Suitably, a plurality of the layers, cells or particles are adjacent to a plurality of other layers, cells or particles. Suitably, the beverage ingredient is substantially immobilized in the matrix. That is to say, the layers, cells or particles of the beverage preparation ingredient are sufficiently bonded to or entrapped within the matrix so as to remain within the matrix when the matrix is subjected to gentle handling. The immobilized layers, cells or particles are likewise substantially immobilized during beverage preparation by water injection through the material, thereby assisting rapid extraction with low back pressure without filter blocking.

The material according to the present invention suitably has sufficient coherency and strength so as to be handled without substantial tearing or rupture, and without substantial loss of the ingredients from the matrix. This enables the material to be shaped and packaged into beverage preparation capsules more easily than loose, particulate beverage preparation ingredients.

In certain embodiments, individual particles or cells of the beverage ingredient are dispersed in a substantially continuous body of the filter matrix. For example, the body may be a nonwoven web of substantially water-insoluble fibers having particles or cells of the beverage ingredient continuously dispersed therein, as described further below. In other embodiments, the matrix comprises or consists essentially a liquid-permeable sintered body of water-insoluble particles, such as thermoplastic particles, having the beverage ingredient dispersed therein.

In yet other embodiments, the matrix has a layered structure and the beverage ingredient is dispersed in the matrix as a plurality of cells or layers. Typically, there are at least two cells or layers, more suitably at least four cells or layers, and preferably at least six, eight or ten cells or layers of the beverage ingredient in the material. The cells or layers may be formed by laminating layers of liquid-permeable matrix material with layers or cells of the beverage ingredient. The laminate may be a simple laminate, or it may be a cellular laminate, for example formed by quilting together two layers of the matrix material with cells of the beverage ingredient in the pockets of the quilt between the layers. Optionally, the material is formed by rolling up a laminate of the matrix material and the beverage ingredient into a spiral (Swiss-roll) as described in more detail below. It will be appreciated that this enables a single layer of the beverage ingredient to be rolled up into a multilayer material.

Suitable materials for forming the matrix are water-insoluble but preferably hydrophilic, food-acceptable materials. For example, they may comprise a liquid-permeable foam material such as a polyurethane foam or an open-cell polyolefin foam. More suitably, the matrix comprises or consists essentially of fibers of substantially water-insoluble material, for example a woven or nonwoven fabric. The fibers making up the matrix may be any suitable food-acceptable fibers such as cellulose fibers, polyolefin fibers or nylon fibers.

In certain embodiments, the filter matrix may comprise or consist essentially of a compostable material. The term “compostable” signifies that the material is substantially broken down within a few months, preferably within a few weeks, when it is composted. Typically, the material is at least about 90% composted within six months, as determined by the method of ISO14855, as in EN13432. Thermoplastic compostable polymers that could be used for the matrix filter include polymers and copolymers of lactic acid and glycolic acid, polyhydroxybutyrates, polyvinyl alcohols (PVOH), ethylene vinyl alcohols (EVOH), starch derivatives, cellulose and cellulose derivatives, and mixtures thereof.

Preferably, the matrix comprises or consists essentially of one or more nonwoven webs or bodies. That is to say, a fibrous web or body characterized by entanglement or point bonding of the fibers. The nonwoven web or body may, for example, comprise or consist essentially of a web prepared by conventional techniques such as air laying, carding, needling, melt-blowing, or spun-bond processes, or combinations of two or more of such processes. The integrity of the web may be increased by melt-bonding of the fibers, for example achieved by the melt-blowing method or my thermal bonding of thermoplastic (e.g. bicomponent) fibers.

The term “melt-blowing” means a method for forming a nonwoven web by extruding a fiber-forming material through a plurality of orifices to form filaments while contacting the filaments with air or other attenuating fluid to attenuate the filaments into fibers and thereafter collecting a layer of the attenuated fibers. The fibers are long and entangled sufficiently that it is usually not possible to remove one complete melt blown fiber from a mass of such fibers or to trace one melt blown fiber from beginning to end.

The term “spun-bond process” means a method for forming a nonwoven web by extruding a low viscosity melt through a plurality of orifices to form filaments, quenching the filaments with air or other fluid to solidify at least the surfaces of the filaments, contacting the at least partially solidified filaments with air or other fluid to attenuate the filaments into fibers and collecting and optionally calendering a layer of the attenuated fibers.

In certain embodiments the beverage ingredient is a particulate, extractable beverage ingredient such as leaf tea or ground coffee. Alternatively or additionally the beverage ingredient may comprise a particulate, soluble beverage ingredient such as a particulate whitener, hot chocolate, sweetener, flavoring agent, coloring agent or fortifying agent.

The particles of the beverage preparation ingredient may be dispersed in the matrix material during the manufacture thereof, for example by blowing the particles into nonwoven webs being formed by air-laying or melt-blowing. Techniques for the incorporation of particles into nonwoven webs and porous sponge matrices are known from the art of absorbent materials and will not be described further here. For example, it is known to disperse activated carbon particles in nonwoven webs and sponges for the preparation of air- and water-permeable filter materials. Suitable processes are described in WO 2006/052694, WO 94/11556, and the various documents cited therein. It is also known to disperse superabsorbent particles in nonwoven webs and sponges for the preparation of absorbent materials. Suitable processes are known for example from WO 03/057104 and the references cited therein.

Alternatively or additionally, one or more soluble beverage ingredients may be dispersed in the matrix as a soluble coating, for example by impregnating the matrix with a solution of the ingredient followed by drying.

In yet other embodiments, the matrix filter is heat resistant, and the beverage ingredient comprises green coffee. The term “green coffee” refers to coffee that is unroasted, or only partially roasted. The green coffee may be prepared for example by grinding green coffee beans, preferably under cryogenic conditions. In these embodiments, the coffee may be roasted in situ in the matrix, thereby retaining more of the volatile aroma compounds in the material that can be lost from conventional roast and ground coffee.

Suitably, the beverage ingredient or ingredients make up from about 25 wt % to about 90 wt. % of the beverage preparation material, for example from about 40 wt. % to about 75 wt. % thereof. In the embodiments having a cellular structure, suitably each cell contains only a small amount of the beverage preparation material, for example from about 10 mg to about 50 mg of the beverage preparation material. In the embodiments having a layered structure, suitably each layer of the beverage preparation material is thin, for example each layer of beverage preparation material may have a thickness of from about 0.1 mm to about 5 mm, for example from about 1 mm to about 3 mm. Suitably, the uncompressed density of the beverage preparation material is from about 0.05 g/cm³ to about 0.5 g/cm³, for example from about 0.1 g/cm³ to about 0.25 g/cm³.

Suitably, the beverage preparation material is in the form of a single coherent piece. The shape of the piece may for example be a sheet, a cylinder, a tapered cylinder, a lentil shape, or a novelty shape such as a coffee-bean shape. Suitably, the piece contains sufficient beverage preparation ingredients for the preparation of a single portion of beverage, i.e. from about 25 to about 500 ml, preferably from about 100 ml to about 250 ml of beverage. For example, the piece may contain from about 2 g to about 25 g of ground coffee or from about 1 g to about 9 g of leaf tea dispersed in the matrix. The uncompressed volume of the piece is suitably from about 1 cm³ to about 100 cm³, for example from about 5 cm³ to about 50 cm³. The piece may be substantially or completely enclosed in a layer of filter material, for example a nonwoven filter scrim, to prevent the escape of any beverage ingredient or matrix fibers from the material during beverage preparation.

In certain embodiments, the piece of beverage preparation material further comprises a liquid distribution tube embedded in the material. This tube assists direct injection of the aqueous liquid through the material. For example, the liquid distribution tube may be a perforated tube. In certain embodiments, the tube extends along the axis of one of the spiral-wound embodiments described above. A liquid injection inlet such as a nozzle may be provided at an end of the tube, whereby beverages can be prepared directly from the piece of material by liquid injection through the inlet. This removes the need for additional capsule components and provides a compact and environmentally friendly beverage preparation product. The material piece may be packaged in a suitable oxygen- and moisture-impermeable container, such as a sachet, prior to use.

In a second aspect, the present invention provides a beverage preparation capsule comprising side walls defining an enclosure, and a beverage preparation material according to any preceding claim sealed within the enclosure.

Suitably, the beverage preparation material in the capsule enclosure is in the form of one or more pieces of the material containing sufficient beverage preparation ingredients for the preparation of a single portion of beverage. Typically, the amount of ingredient contained in the matrix inside the capsules is sufficient for the preparation of one portion of beverage, i.e. from about 25 to about 500 ml, preferably from about 100 ml to about 250 ml of beverage. For example, the package may contain from about 2 g to about 25 g of ground coffee or from about 1 g to about 9 g of leaf tea dispersed in the matrix.

The capsule is suitable substantially impermeable to oxygen and moisture in order to preserve the freshness of the beverage ingredient. Typically, each capsule comprises a plastics sheet (e.g. thermoformed or injection molded sheet) and/or flexible film material. The sheet or flexible film material will usually be a laminate comprising two or more of the following layers: a thermoplastic sealant layer for bonding the sheet to other members of the package; a substantially gas-impermeable barrier layer, which preferably is a metal film such as aluminum film; adhesion layers to improve adhesion between other layers of the laminate; structural layers, for example to provide puncture resistance; and/or a printing substrate layer. The structural layers could be made of polyolefins, polyester, nylons, or other polymers as is well known in the art.

In one group of embodiments, the capsule may comprise two similar or identical sheets of flexible film material bonded together around a margin to form a film sachet or capsule. In another group of embodiments the capsules may comprise a first sheet that has been formed, e.g. by thermoforming, into a cup or bowl shape with a flanged rim, and a second sheet that is bonded across the flanged rim to form the capsule. For example, the first sheet may be a relatively stiff thermoplastic sheet that has been thermoformed into a cup or bowl shape with a flanged rim, and the second sheet is a flat sheet, which may be of flexible film material, that is bonded across the flanged rim. Suitable capsule embodiments are described for example in the references listed above.

The capsule may further comprise a filter element, for example a layer of filter sheet material, in the capsule to reduce or prevent the escape of particles of the beverage preparation material (for example, fibers of the matrix or particles of coffee) with the beverage in use. The filter element is therefore located downstream of the beverage preparation material in use. Typically, the filter element is similar to the filter elements currently provided in existing beverage capsule formats.

In a third aspect, the present invention provides a method of preparing a beverage, comprising the step of passing an aqueous liquid through a beverage preparation material according to the present invention. Suitably, the liquid is passed through the beverage preparation material in a capsule according to the invention. The aqueous liquid is preferably water, for example at a temperature of 85° C. to 99° C. The method may be performed in the beverage preparation apparatus already known for use with existing capsule formats, for example as described in the patent references listed above, without modification of the apparatus.

In certain embodiments, the method according to this aspect of the invention may start from a material containing a green coffee as herein before described. In these embodiments, the method further comprises roasting the coffee in situ in the material prior to the step of passing aqueous liquid through the material. Roasting may be performed by heating the material containing the coffee to a temperature of 250° C.-450° C. for a period of from about 10 seconds to about 10 minutes, for example about 30 seconds to about 5 minutes. Suitably, the step of roasting is performed shortly before the step of passing aqueous liquid, for example from about 10 seconds to about 24 hours before, suitably from about 1 minute to about 1 hour before.

### BRIEF DESCRIPTION OF THE DRAWINGS

Specific embodiments of the present invention will now be described further, by way of example, with reference to the accompanying drawings, in which:

FIG. 1 shows a cross-sectional view through a beverage preparation material according to the present invention;

FIG. 2 shows an enlarged detail view of part of the material of FIG. 1;

FIG. 3 shows a side elevation view of a first beverage preparation capsule according to the present invention;

FIG. 4 shows a longitudinal cross section through the beverage preparation capsule of FIG. 3;

FIG. 5 shows a perspective view of a second beverage preparation capsule according to the present invention;

FIG. 6 shows a longitudinal cross section through the beverage preparation capsule of FIG. 5;

FIG. 7 shows a plan view of a third beverage preparation capsule according to the present invention;

FIG. 8 shows a longitudinal cross section through the beverage preparation capsule of FIG. 7;

FIG. 9 shows a schematic transverse cross section through a spiral-wound layered material according to another embodiment of the present invention;

FIG. 10 shows a longitudinal cross section through a laminated material according to another embodiment of the present invention;

FIG. 11 shows a schematic longitudinal cross section through a quilted sheet for use in making further embodiments of the invention;

FIG. 12 shows a schematic transverse cross-section through a spiral-wound layered material according to another embodiment of the present invention formed from the quilted cellular material of FIG. 11; and

FIG. 13 shows a schematic longitudinal cross-section through a spiral-wound piece of material similar to that of FIG. 9, incorporating a liquid distribution tube.

### DETAILED DESCRIPTION OF THE INVENTION

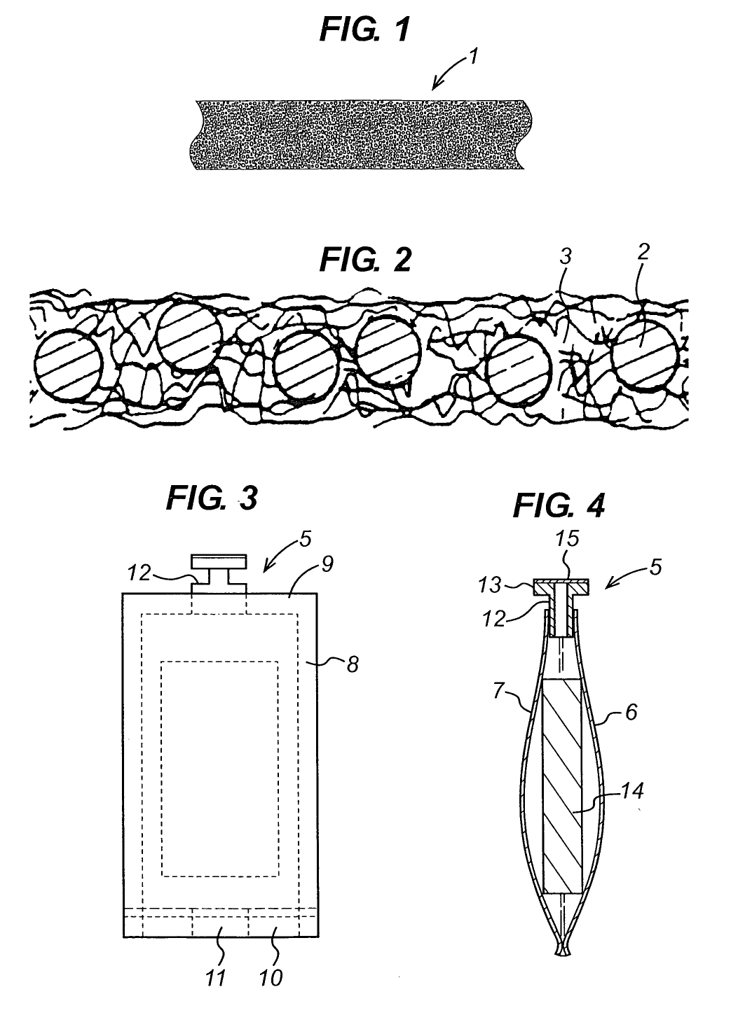

Referring to FIGS. 1 and 2, the beverage preparation material 1 according to this embodiment of the invention comprises ground coffee particles 2 dispersed in a meltblown fiber matrix 3. The coffee makes up about 80 wt. % of the material. The fiber matrix is formed from polypropylene fibers. The material may be prepared as described in WO 2006/052694.

Referring to FIGS. 3 and 4, the capsule 5 according to this embodiment of the invention is generally similar to the sachet described in EP-A-0179641. It comprises two flexible laminate sheets 6,7. Each laminate sheet comprises an inner thermoplastic sealing film. The front and back sheets 6,7 are bonded together along edge seams 8, top seam 9 and bottom seam 10. A central region 11 of the bottom seam 9 is bonded with a peelable adhesive that can be released by the action of heat and/or pressure of liquid inside the capsule. A nozzle 12 is inserted into the top seam 9 of the capsule. The nozzle 12 has a central cylindrical bore sealed at the top by membrane 15. A flange 13 on the nozzle enables the capsule to be gripped by a clamp.

Within the capsule there is a single pad 14 of the beverage preparation material shown in FIGS. 1 and 2. The dimensions of the pad 14 and the capsule 5 are selected such that the capsule contains about 15 g of coffee. The capsule provides an oxygen and moisture-impermeable enclosure for the coffee until the sachet is used.

In use, the capsule is inserted into a suitable beverage brewing machine, where it is gripped by a clamp (not shown) under the nozzle flange 13. A hollow needle is inserted into the nozzle bore to pierce the membrane seal 15, and hot water is injected at a pressure of approximately 0.5 bar gauge to brew coffee inside the capsule. The pressure of the hot water causes the weakly bonded margin region 11 at the bottom of the sachets to peel apart, releasing the resulting coffee in a controlled fashion whilst retaining the pad 14 inside the capsule.

In alternative embodiments, the sachet 5 may contain a filter element 16 similar to that in the sachets of EP-A-0179641 to block the passage of any fibers or coffee grounds that escape from pad 14 during brewing.

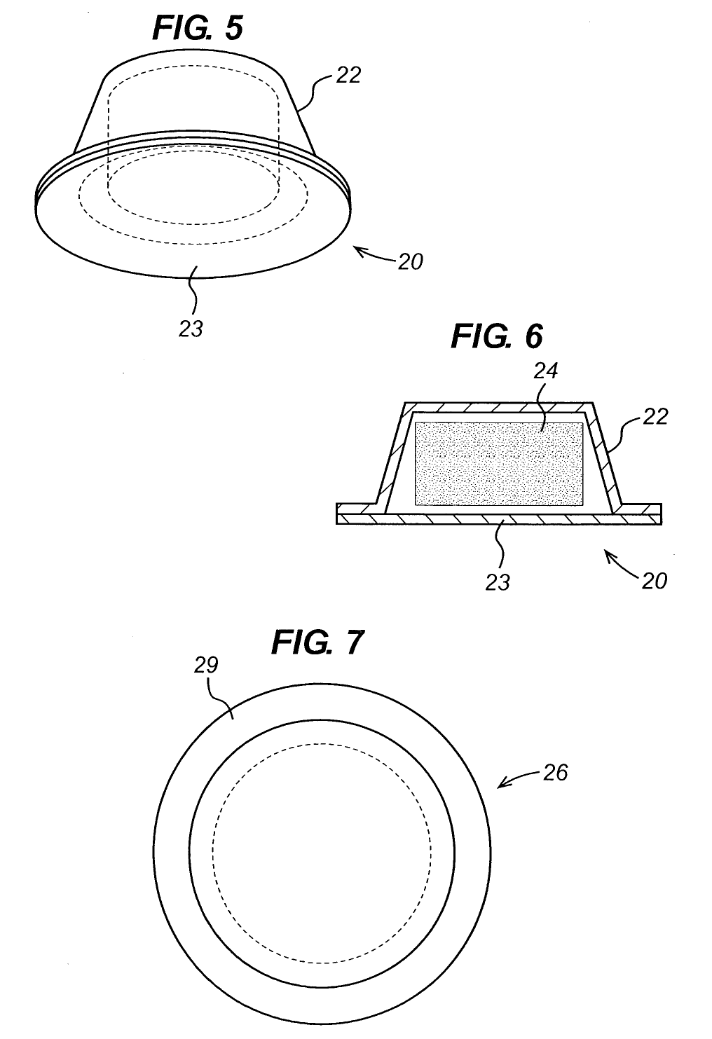

Referring to FIGS. 5 and 6, the beverage brewing capsule 20 according to this embodiment is of a second conventional type in the form of a thermoformed plastic cup portion 22 having a flange 25 projecting circumferentially around the lip of the cup 22. A circular cover sheet 23 of thermoplastic sheet or flexible film is sealed to the flange 22 over the top of the cup 22 to provide an air-tight enclosure. A pad 24 of the beverage making material according to the present invention is located inside the capsule.

In use, the capsule 20 is held in a clamp in a suitable beverage preparation apparatus. The clamp is equipped with an injector tube or other piercing means to pierce the cover sheet 23. Hot water is injected into the capsule to prepare coffee inside the capsule. The clamp further comprises a second injector tube or other piercing means to pierce the base of the cup 22, from where the coffee flows to a suitable receptacle. In certain embodiments, both the liquid injection and the escape of the coffee take place through respective injector and outlet tubes pierced through the cover 23.

In alternative embodiments, a filter sheet (not shown) may be provided in the base of cup portion 22 to block the passage of any fibers from pad 24 into the receptacle.

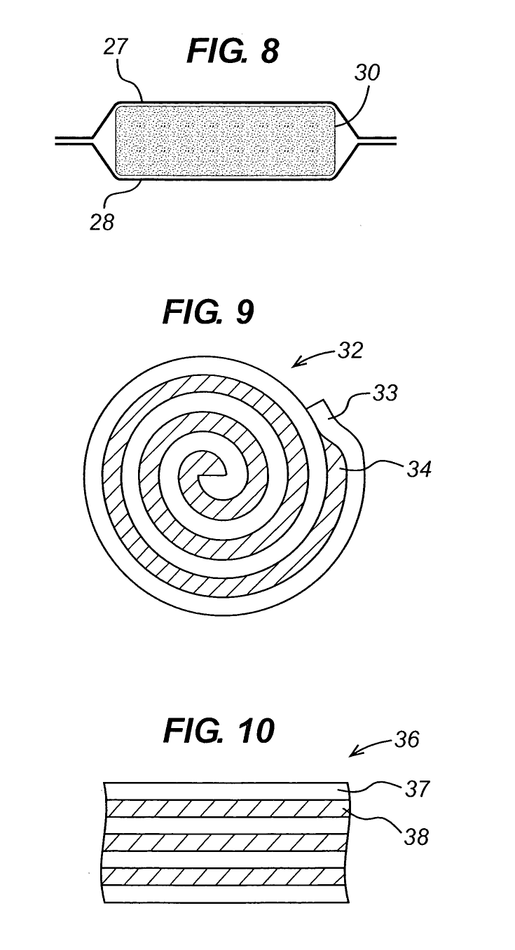

Referring to FIGS. 7 and 8, the beverage brewing capsule 26 according to this embodiment is of a third conventional type in the form of a pod formed from front and back faces 27,28 of flexible sheet material bonded together around margin 29 to form a pillow-shaped enclosure that contains the pad 30 of beverage preparation material according to the present invention.

Suitably, the flexible sheet material is substantially impermeable to air and liquids, thereby maintaining freshness of the coffee inside the pod. In these embodiments, the capsule 26 is held in a clamp in a suitable beverage preparation apparatus. The clamp is equipped with piercing means to pierce the first sheet 27. Hot water is injected into the capsule to prepare coffee inside the capsule. The clamp further comprises a second piercing means to pierce the second sheet 28, from where the coffee flows to a suitable receptacle.

In other embodiments, the front 27 and back 28 sheets of the pod 26 may be formed of liquid-permeable sheet material, such as a filter sheet material. In these embodiments the pod is inserted into the clamp of the beverage making apparatus and hot water is pumped through the sheet 27 into the pod, and coffee is allowed to escape through the other sheet 28 into a suitable receptacle. There is no need to pierce the sheets, which reduces the chance that fibers from the material 30 will escape to contaminate the coffee.

Referring to FIG. 9, the material according to this embodiment of the invention is a spiral roll 32 formed by winding up a laminate consisting of a layer 34 of ground coffee and a layer 33 of nonwoven textile matrix material. It will be appreciated that the roll 32 can be cut into lengths each containing sufficient ground coffee for a single portion of beverage. The pieces can then be inserted into a capsule as described.

It will be appreciated that materials according to the present invention comprising multiple layers of beverage making ingredient can be formed in various ways. For example, FIG. 10 shows a laminate material 36 according to the present invention formed by stacking a plurality of layers 38 of ground coffee and layers 37 of nonwoven filter sheet material.

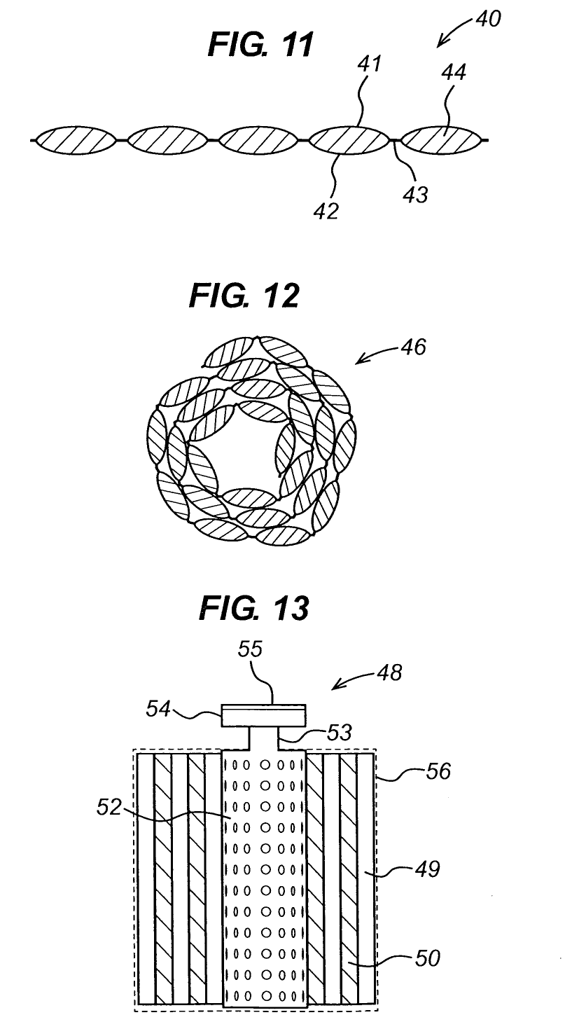

FIG. 11 shows a quilted sheet 40 formed from two webs 41,42 of nonwoven filter sheet material containing thermoplastic fibers. The filter sheet materials used to form conventional coffee bags or coffee pods would be suitable. The webs 41,42 are bonded together in regions 43 forming a square quilt, thereby defining a grid of square pockets 42. Each of the pockets 42 forms a cell that contains ground coffee 44. The cells of ground coffee are deposited on the lower web 42 immediately before bonding the upper web onto the lower web. The quilted sheet 40 may then be stacked or folded into various materials according to the present invention. A representative cellular material according to the invention is shown in FIG. 12, which has been formed by rolling up the sheet of FIG. 11 and cutting it into lengths.

FIG. 13 shows a beverage preparation pod 48. The pod 48 comprises a spiral-wound laminate similar to that of FIG. 9 comprising concentric layers of coffee 50 and nonwoven filter sheet 49. The pod 48 further comprises a perforated liquid distribution tube 52 extending along the central axis of the pod. The bottom of the liquid distribution tube is closed. The top of the liquid distribution tube is provided with an inlet nozzle 53 having a flange 54 to allow the nozzle to be grasped by a clamp of a beverage dispensing machine of the FLAVIA type. A foil seal 55 extends over the inlet opening of the nozzle. Finally, an envelope 56 formed of a nonwoven filter web of the kind conventionally used for coffee filtration encloses the pod 48. The pod 48 may be stored before use in an oxygen- and moisture-impermeable package, such as a sachet. In use, the pod 48 may be inserted into the clamp of a FLAVIA type beverage machine. A liquid injector tube is inserted into the nozzle 53 and injects hot water into the liquid distribution tube 52. The hot water is force through the laminate, where it contacts the ground coffee. The resulting coffee beverage flows out of the pod and into a receptacle under gravity.

The above embodiments have been described by way of example only. Many other embodiments falling within the scope of the accompanying claims will be apparent to the skilled reader.

1. A beverage preparation material comprising:
a substantially insoluble and water-permeable filter matrix having a beverage ingredient dispersed therein,
wherein a plurality of layers, cells, or individual particles of said beverage ingredient are held in a spaced-apart relationship within said material by regions of said filter matrix.

2. The beverage preparation material according to claim 1, wherein individual layers, particles or cells of said beverage ingredient are dispersed in a substantially continuous body of said filter matrix.

3. The beverage preparation material according to claim 1, wherein the filter matrix comprises or consists essentially of a nonwoven body of fibers.

4. The beverage preparation material according to claim 1, wherein the matrix comprises or consists essentially of a liquid-permeable sintered body of water-insoluble particles.

5. The beverage preparation material according to claim 1, wherein the material comprises a plurality of layers of liquid-permeable matrix material sandwiching layers or cells of the beverage ingredient.

6. The beverage preparation material according to claim 5, wherein said plurality of layers has been formed by winding up a laminate into a spiral.

7. The beverage preparation material according to claim 1, wherein the beverage ingredient is a particulate, extractable beverage ingredient such as leaf tea or ground coffee.

8. The beverage preparation material according to claim 1, wherein the beverage ingredient or ingredients make up from about 25 wt % to about 90 wt. % of the beverage preparation material.

9. The beverage preparation material according to claim 1, wherein the matrix filter is heat resistant, and the beverage ingredient comprises green coffee.

10. The beverage preparation material according to claim 1, wherein the filter matrix comprises a compostable material.

11. A beverage preparation pod comprising:
a piece of a beverage preparation material comprised of a substantially insoluble and water-permeable filter matrix having a beverage ingredient dispersed therein, wherein a plurality of layers, cells, or individual particles of said beverage ingredient are held in a spaced-apart relationship within said material by regions of said filter matrix; and
a liquid distribution tube inserted into said piece.

12. The beverage preparation pod according to claim 11, further comprising an envelope of filter sheet material enclosing said pod.

13. A beverage preparation capsule comprising:
side walls defining an enclosure, and a beverage preparation material comprised of a substantially insoluble and water-permeable filter matrix having a beverage ingredient dispersed therein, wherein a plurality of layers, cells, or individual particles of said beverage ingredient are held in a spaced-apart relationship within said material by regions of said filter matrix whereby the beverage preparation material is sealed within the enclosure.

14. The beverage preparation capsule according to claim 13, wherein the beverage preparation material in said enclosure comprises one or more pieces of said material containing sufficient beverage preparation ingredients for the preparation of a single portion of beverage.

15. The beverage preparation capsule according to claim 13, further comprising a filter element in the capsule to reduce or prevent the escape of particles of the beverage preparation material from the capsule in use.

16. A method of preparing a beverage, comprising:
the step of passing an aqueous liquid through a beverage preparation material comprised of a substantially insoluble and water-permeable filter matrix having a beverage ingredient dispersed therein, wherein a plurality of layers, cells, or individual particles of said beverage ingredient are held in a spaced-apart relationship within said material by regions of said filter matrix.
